(19) United States
(12) Patent Application Publication
(10) Pub. No.: US 2023/0391140 A1
(43) Pub. Date: Dec. 7, 2023

(54) Composite tire structure

(71) Applicant: Jinquan XIE, Jiangsu Province (CN)

(72) Inventor: Jinquan XIE, Jiangsu Province (CN)

(21) Appl. No.: 18/199,374

(22) Filed: May 19, 2023

(30) Foreign Application Priority Data
Jun. 2, 2022 (CN) 202221376954.9

(51) Int. Cl. B60C 9/02; B60C 1/00; B60C 9/00

(52) U.S. Cl. CPC B60C 9/0238; B60C 1/0008; B60C 9/005; B60C 2009/0071

(57) ABSTRACT

A composite tire, having an outer tube and an inner tube made of different materials or the same material but in different densities; an inner circumferential surface of the outer tube is integrally formed with protruding rings; projections or slots are provided on each of the protruding rings; the inner tube is integrated to the inner circumferential surface of the outer tube; the inner tube is divided into different layers made of different materials or the same material but in different densities; the inner tube engages with the protruding rings such that if the projections are provided on each of the protruding rings, the projections are wrapped by the inner tube, or if the slots are provided on each of the protruding rings, the slots are filled by the inner tube. The composite tire is resistant to wearing and also comfortable to use.

### BACKGROUND OF THE INVENTION

The present invention relates to the technical field of tires, and more specifically relates to a composite tire structure.

Compared with pneumatic tires, solid tires are not required to be framed by cords forming the cord plies and also not required to be inflatable. Therefore, even if sharp objects pierce through the surfaces of the solid tires, solid tires will not explode and hence being safer to use. Solid tires in the market can be made by various materials, among which rubber and PU are more common. These two materials have their own advantages: rubber tires are more resistant to wearing, but harder and heavier, and thus more effort draining and less comfortable to use, while PU tires are softer and more comfortable to use, and can be mounted to wheel hubs by using a tire mounting device, but less resistant to wearing.

A kind of composite tire has been developed that combines the advantages of both rubber and PU tires, such that it is resistant to wearing and also comfortable to use. However, during production, the integration of an inner tube into an outer tube of the composite tire is not satisfying. Especially, when the composite tire is wide, the inner tube and the outer tube may be easily separated from each other (particularly near to the middle part) and hence form a gap which results in noise during use. Therefore, user's experience is bad.

### BRIEF SUMMARY OF THE INVENTION

An object of the present invention is to provide a composite tire structure that ensures secured integration of the inner tube into the outer tube of the tire so as to prevent noise.

To achieve the above object, the present invention provides the following solutions:

A composite tire, comprising an outer tube and an inner tube; the outer tube and the inner tube are made of different materials respectively, or made of a same material but in different densities respectively; an inner circumferential surface of the outer tube is integrally formed with a plurality of protruding rings; a plurality of projections or slots are provided on each of the protruding rings; the inner tube is integrated to the inner circumferential surface of the outer tube; the inner tube is divided into different layers along a radial direction thereof; the different layers of the inner tube are made of different materials respectively or a same material but in different densities respectively; when the inner tube is integrated into the inner circumferential surface of the outer tube, the inner tube engages with the plurality of protruding rings such that if said plurality of projections are provided on each of the protruding rings, said plurality of projections are wrapped by the inner tube, or if said slots are provided on each of the protruding rings, the slots are filled by the inner tube.

Each of said slots is a through hole that penetrates through two side surfaces of a corresponding protruding ring.

Said slots are disposed along a circumferential direction of each of the protruding rings, and are spaced apart from one another on each of the protruding rings by equal distances.

Each of the slots is a kidney shaped hole.

Materials forming the inner tube, the outer tube, and the different layers of the inner tube are chosen from expanded thermoplastic polyurethane (ETPU), ethylene-vinyl acetate (EVA), polyurethane (PU), and reinforced plastics (RP).

Each of the protruding rings protrudes in a direction parallel to two sides of the composite tire; the protruding rings are spaced apart from each other by equal distances.

A tire tread of the outer tube contains anti-slippery patterns.

A thickness of the outer tube is equal along a circumferential direction thereof.

The inner tube is centrifugally molded to the inner circumferential surface of the outer tube by using a foaming machine.

According to the above technical solutions, the composite tire of the present invention comprises an outer tube and an inner tube integrated into the outer tube. The outer tube and the inner tube are made of different materials. Through combinations of different materials, the composite tire is both resistant to wearing and comfortable to use. The protruding rings and the projections/slots thereon can achieve position limiting between the outer tube and the inner tube to achieve more secured integration between the outer tube and the inner tube. During use of the composite tire, the inner tube will not be separated from the outer tube, thus noise is prevented, and no gaps are formed between the inner tube and the outer tube which may otherwise affect the user's experience. Accordingly, the service life of the composite tire is longer. Besides, different layers of the inner tube can be made of the same material but in different densities to increase the comfort of user while using the composite tire, also, different densities of different layers of the inner tube can be adjusted to meet different customers' demands, thereby increasing the competitiveness of the composite tire of the present invention in the market.

### BRIEF DESCRIPTION OF THE DRAWINGS

FIG. 1 is a perspective view of the present invention according to an embodiment.

FIG. 2 is a perspective exploded view of the present invention according to an embodiment.

FIG. 3 is a sectional view of the present invention according to an embodiment.

In the figures:

1-outer tube; 11-protruding ring; 12-slot; 13-anti-slippery pattern; 2-inner tube.

### DETAILED DESCRIPTION OF THE INVENTION

In order to further explain the technical solutions of the present invention, the present invention is further described below in detail with reference to the accompanying drawings.

A composite tire, comprising an outer tube 1 and an inner tube 2. The outer tube 1 and the inner tube 2 can be made of different materials respectively, or can be made of a same material but in different densities respectively.

An inner circumferential surface of the outer tube 1 is integrally formed with a plurality of protruding rings 11; a plurality of projections or slots 12 are provided on each of the protruding rings 11.

The inner tube 2 is integrated to the inner circumferential surface of the outer tube 1; the inner tube 2 is divided into different layers along a radial direction thereof; the different layers of the inner tube 2 can be made of different materials respectively or a same material but in different densities respectively; when the inner tube 2 is integrated to the inner circumferential surface of the outer tube 1, the inner tube 2 engages with the plurality of protruding rings 11 such that if said plurality of projections are provided on each of the protruding rings 11, said plurality of projections are wrapped by the inner tube 2, or if said slots are provided on each of the protruding rings 11, the slots are filled by the inner tube 2.

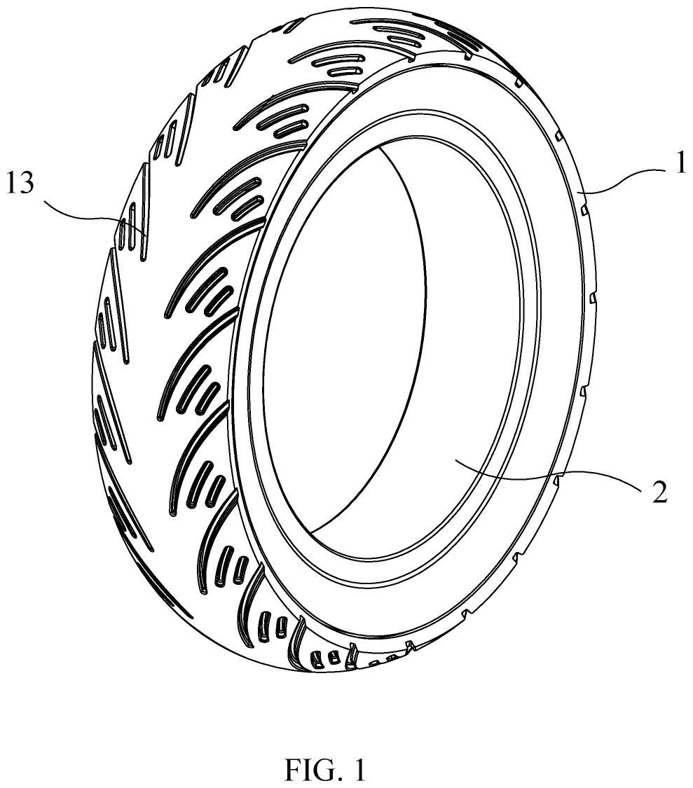

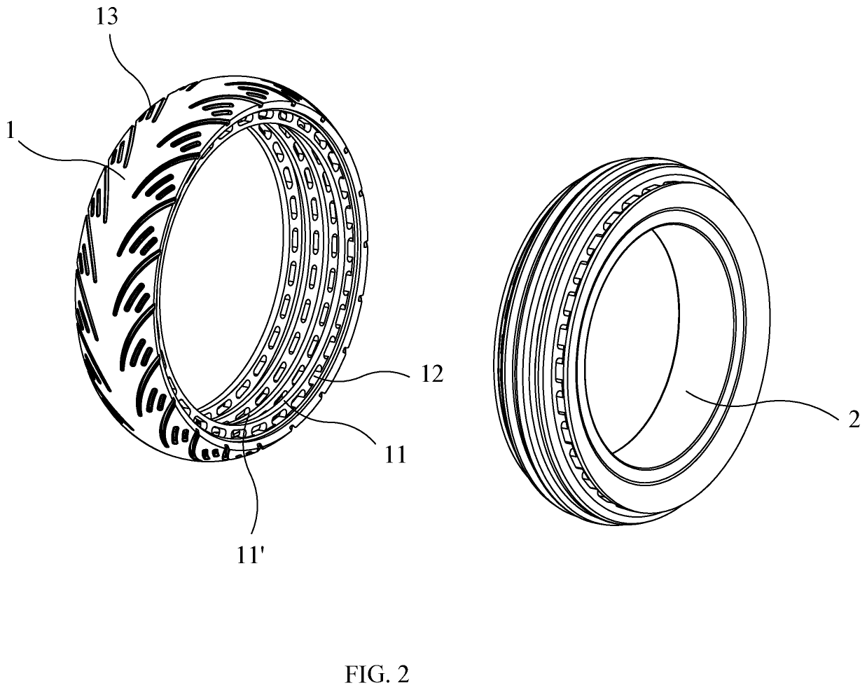

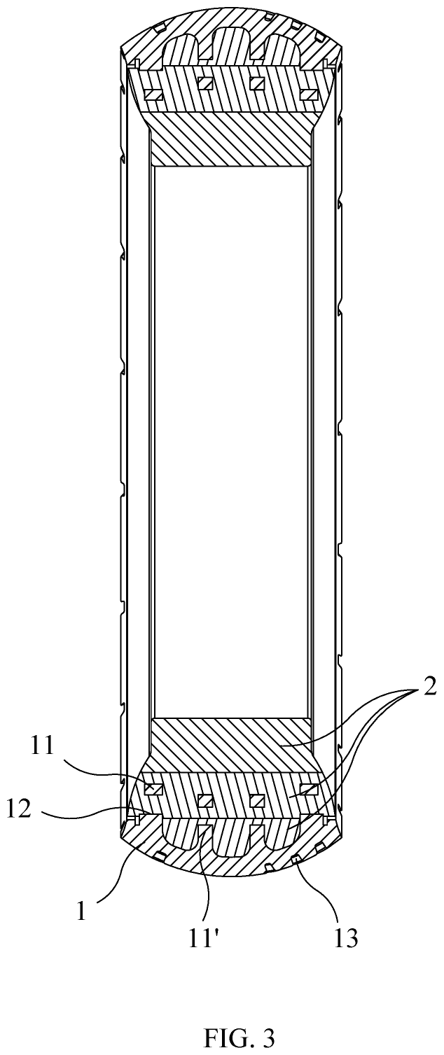

FIGS. 1-3 illustrate a detailed embodiment of the present invention.

In this embodiment, said slots 12 are provided on each of the protruding rings 11, and each of said slots 12 is a through hole that penetrates through two side surfaces of a corresponding protruding ring 11; by forming the slots 12 as through holes, at least one material forming the inner tube 2 can be filled into the slots 12 of the protruding rings 11 when the inner tube 2 is integrated into the outer tube 1, thereby achieving more secured integration of the inner tube 2 into the outer tube 1 better in preventing mutual separation and loosening so that the service life of the tire is longer.

Furthermore, the slots 12 are disposed along a circumferential direction of each of the protruding rings 11, and are spaced apart from one another on each of the protruding rings 11 by equal distances. Therefore, when the outer tube 1 and the inner tube 2 tend to displace with respect to each other during use, different positions along the circumferential direction of each of the protruding rings 11 receive equal force and thereby preventing accelerated aging of a particular portion of the composite tire and hence increasing the service life of the composite tire.

Further, each of the slots is a kidney shaped hole. In other words, two ends of each of the slots are both in an arc shape to ensure strength and resilience at the two ends of each of the slots, so that after the slots 12 are formed on each of the protruding rings 11, each protruding ring 11 can still maintain a certain extent of mechanical strength. Besides, a sufficient length is provided between the two ends of each of the slots to allow said at least one material of the inner tube 2 to fill in, thereby ensuring secured integration of the inner tube 2 into the outer tube 1.

Materials as mentioned above are chosen from expanded thermoplastic polyurethane (ETPU), ethylene-vinyl acetate (EVA), polyurethane (PU), reinforced plastics (RP) and the like.

Each of the protruding rings 11 protrudes in a direction parallel to two sides of the composite tire; the protruding rings 11 are spaced apart from each other by equal distances. Accordingly, all the protruding rings 11 receive equal amount of force during use of the composite tire, and the force is always acted towards a center of the composite tire to ensure that the vehicle that uses the composite tire of the present invention can move stably.

A tire tread of the outer tube 1 contains anti-slippery patterns 13 to increase frictional forces between the composite tire and the ground so as to achieve anti-slippery effect. In the present embodiment, the anti-slippery patterns 13 are formed as grooves.

A thickness of the outer tube 1 is equal along a circumferential direction thereof, so that when the inner tube 2 is integrated into the outer tube 1, different positions along the circumferential direction of the outer tube 1 are given the same hardness. No particular position along the circumferential direction of the outer tube 1 is particularly thick that may give an excessive hardness to the composite tire at that particular position, which may otherwise affect user's experience.

The inner tube 2 is centrifugally molded to the inner circumferential surface of the outer tube 1 by using a foaming machine, thereby integrating the inner tube 2 to the outer tube 1. Centrifugally molding of the inner tube 2 is carried out several times so that the inner tube 2 as formed contains different layers of different densities, and so that said at least one material of the inner tube 2 can be more sufficiently and securely filled in between the protruding rings 11, thereby ensuring secured integration of the inner tube 2 to the outer tube 1. Therefore, during use of the composite tire, the inner tube 2 will not be easily separated from the outer tube 1.

According to the above technical solutions, the composite tire of the present invention comprises an outer tube 1 and an inner tube 2 integrated into the outer tube 1. The outer tube 1 and the inner tube 2 are made of different materials. Through combinations of different materials, the composite tire is both resistant to wearing and comfortable to use. The protruding rings 11 and the projections/slots 12 thereon can achieve position limiting between the outer tube 1 and the inner tube 2 to achieve more secured integration between the outer tube 1 and the inner tube 2. During use of the composite tire, the inner tube 2 will not be separated from the outer tube 1, thus noise is prevented, and no gaps are formed between the inner tube 2 and the outer tube 1 which may otherwise affect the user's experience. Accordingly, the service life of the composite tire is longer. Besides, different layers of the inner tube 2 can be made of the same material but in different densities to increase the comfort of user while using the composite tire, also, different densities of different layers of the inner tube 2 can be adjusted to meet different customers' demands, thereby increasing the competitiveness of the composite tire of the present invention in the market.

What is claimed is:

1. A composite tire, comprising:
an outer tube and an inner tube; the outer tube and the inner tube are made of different materials respectively, or made of a same material but in different densities respectively;
an inner circumferential surface of the outer tube is integrally formed with a plurality of protruding rings; a plurality of slots are provided on each of the protruding rings;
the inner tube is integrated to the inner circumferential surface of the outer tube; the inner tube is divided into different layers along a radial direction thereof; the different layers of the inner tube are made of different materials respectively or a same material but in different densities respectively; when the inner tube is integrated into the inner circumferential surface of the outer tube, the inner tube engages with the plurality of protruding rings such that said slots are filled by the inner tube.

2. The composite tire of claim 1, wherein each of said slots is a through hole that penetrates through two side surfaces of a corresponding protruding ring.

3. The composite tire of claim 2, wherein said slots are disposed along a circumferential direction of each of the protruding rings, and are spaced apart from one another on each of the protruding rings by equal distances.

4. The composite tire of claim 2, wherein each of the slots is a kidney shaped hole.

5. The composite tire of claim 1, wherein materials forming the inner tube, the outer tube, and the different layers of the inner tube are chosen from expanded thermoplastic polyurethane (ETPU), ethylene-vinyl acetate (EVA), polyurethane (PU), and reinforced plastics (RP).

6. The composite tire of claim 1, wherein each of the protruding rings protrudes in a direction parallel to two sides of the composite tire; the protruding rings are spaced apart from each other by equal distances.

7. The composite tire of claim 1, wherein a tire tread of the outer tube contains anti-slippery patterns.

8. The composite tire of claim 1, wherein a thickness of the outer tube is equal along a circumferential direction thereof.
